(19) United States
(12) Patent Application Publication
(10) Pub. No.: US 2006/0132614 A1
(43) Pub. Date: Jun. 22, 2006

(54) Image stabilizer of camera

(75) Inventors: Hong-seok Lee, Seongnam-si (KR); Seung-ho Nam, Seongnam-si (KR); Mee-suk Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/269,823

(22) Filed: Nov. 9, 2005

(30) Foreign Application Priority Data
Dec. 21, 2004 (KR) 10-2004-0109599

(51) Int. Cl. H04N 5/228

(52) U.S. Cl. 348/208.7

(57) ABSTRACT

An image stabilizer of a camera is provided that can compensate for the effects of the shaking of a main body that includes a lens, in real-time, by using an optical element. The image stabilizer includes: an optical element that can be tilted, which is installed on an optical path, which transmits light and which tilts to shift the transmitted light to compensate for the optical path; a sensor provided near the main body, which senses the shaking of the main body; a calculating unit which receives a sensing signal from the sensor and calculates the necessary tilt angle of the optical element; and an actuator which drives the optical element according to the result output from the calculating unit. The image stabilizer can sense the shaking of the main body in real-time and prevent shifting of the image formed on an image forming surface.

### CROSS-REFERENCE TO RELATED APPLICATIONS

This application claims priority from Korean Patent Application No. 10-2004- 0109599, filed on Dec. 21, 2004 in the Korean Intellectual Property Office, the disclosure of which is incorporated herein in its entirety by reference.

### BACKGROUND OF THE INVENTION

1. Field of the Invention

Apparatuses consistent with the present invention relate to an image stabilizer of a camera, and more particularly, to an image stabilizer of a camera that can compensate for camera shake in real-time when photographing.

2. Description of the Related Art

When people take photographs using still cameras, such as digital cameras, film cameras, or video cameras, they usually hold the camera in their hands, without using a tripod or other steadying device. This can result in blurry images due to shaking of the user's hands.

The shaking of the camera is caused by two motions: pitching and yawing. The pitching motion is up and down movement on a horizontal axis, and the yawing motion is left and right movement on a vertical axis.

When taking a photograph, the camera is moved slightly when the user presses the shutter release button, which is located eccentrically from the center of mass of the camera. If the amount of light which comes into a camera is small, the exposure time of the camera must be long, and in this case camera shaking makes a blurred image.

Considering the above, a conventional image stabilizer of a camera has been disclosed as illustrated in FIGS. 1A, 1B and 1C.

Referring to FIG. 1A, the conventional image stabilizer includes first and second glass plates 11 and 13, and a bellows 14 interposed between the first and second glass plates 11 and 13. The bellows 14 is made of a resin such as polyethylene. The ends of the bellows 14 are fixed to the edges of the first and second glass plates 11 and 13 to form a closed internal space between the first and second glass plates 11 and 13, and the bellows 14 is expanded and contracted by an outside force. A transparent liquid 12 having a higher refractive index than air fills the internal space between the first and second glass plates 11 and 13.

When the camera is held still, the first and second glass plates 11 and 13 are maintained parallel to each other as illustrated in FIG. 1A. Therefore, the optical axis 15 passes straight through the first and second glass plates 11 and 13 without being refracted.

However, when the camera is shaken, the first glass plate 11 is tilted with respect to the second glass plate 13, as illustrated in FIGS. 1B and 1C, according to the direction of the camera shake, thereby expanding and contracting the bellows 14. Therefore, optical axes 16 and 17 of the incident light can be refracted as illustrated in FIGS. 1B and 1C, respectively.

As described above, the adjustment of the relative angle between the first and second glass plates 11 and 13 is performed by detecting the degree of camera shake through a sensor, and then by operating an actuator (not shown) which moves the first and second glass plates 11 and 13. Thus, by making the output angle of the light different from the incident angle of the light, the blurry image caused by camera shake can be prevented.

However, in such a conventional image stabilizer of the camera, the bellows 14 can wear out after extended use, and the liquid 12 can leak and contaminate the inside of the camera.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An apparatus consistent with the present invention provides an image stabilizer of a camera which eliminates the possibility of contamination of the inside of the camera caused by leaking liquid, by not using a bellows and a liquid, and which has a structure which allows camera shake compensation in real-time.

According to an aspect of the present invention, there is provided an image stabilizer of a camera which focuses an image on an image forming surface by compensating for shaking of a main body of the camera including a lens. The image stabilizer includes: an optical element that can be tilted which is installed on an optical path, which transmits light and tilts to shift the transmitted light to compensate for the optical path; a sensor provided near the main body, which senses the shaking of the main body; a calculating unit which receives a sensing signal from the sensor and calculates the necessary tilt angle of the optical element; and an actuator which drives the optical element according to the result output from the calculating unit. The image stabilizer senses the shaking of the main body in real-time and prevents shifting of the image focused on the image forming surface.

### BRIEF DESCRIPTION OF THE DRAWINGS

The above and other aspects of the present invention will become more apparent by describing in detail exemplary embodiments thereof with reference to the attached drawings, in which:

FIGS. 1A, 1B and 1C are cross-sections of a conventional image stabilizer of a camera;

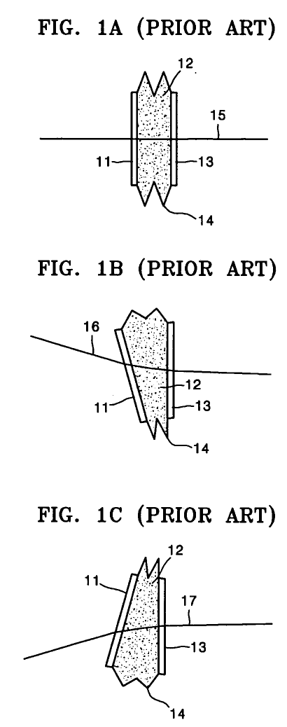

FIGS. 2A and 2B are views of an image stabilizer of a camera according to an exemplary embodiment of the present invention;

FIG. 3 is a schematic perspective view of the image stabilizer of a camera according to an exemplary embodiment of the present invention; and

FIGS. 4A and 4B are schematic views of an image stabilizer of a camera according to another exemplary embodiment of the present invention.

### DETAILED DESCRIPTION OF EXEMPLARY EMBODIMENTS OF THE INVENTION

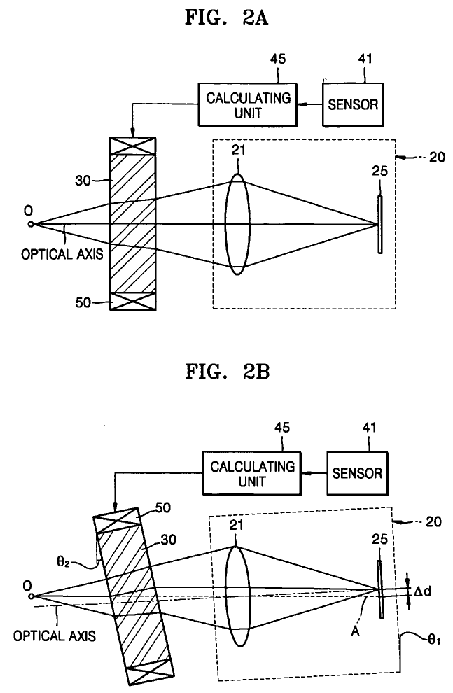

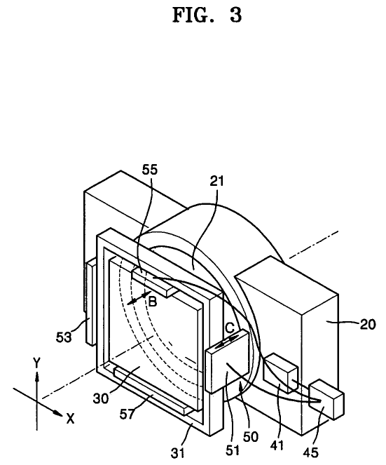

FIGS. 2A, 2B and 3 are views of the optical arrangement of an image stabilizer of a camera according to an exemplary embodiment of the present invention. FIG. 2A illustrates an instance when there is no shaking of a main body 20 of the camera, and FIG. 2B illustrates an instance when the main body 20 is tilted counterclockwise by an angle Θ₁ compared to the position of the main body 20 of the camera as shown in FIG. 2A.

Referring to FIGS. 2A, 2B and 3, the image stabilizer of the camera compensates for the shaking of the main body 20, which includes a lens 21 to form an image on an image forming surface 25. To do so, the image stabilizer includes a tiltable optical element 30 formed on an optical path, a senor 41, which senses the shaking of the main body 20, a calculating unit 45 which calculates the degree of the tilt of the optical element 30, and an actuator 50 which drives the optical element 30.

The optical element 30 changes the optical path of light transmitted through it according to its tilt angle. That is, by adjusting the focal point of the image on the image forming surface 25, shifting caused by shaking of the main body 20 is prevented.

To achieve this, the optical element 30 is made of flat glass having a higher refractive index than air, and is located on the optical path between a subject O and the lens 21.

Therefore, when there is no shaking of the main body 20, the subject O is on the optical axis of the lens 21, as illustrated in FIG. 2A. Thus, the center of the light that passes through the optical element 30 is perpendicular to the incident surface of the optical element 30, thereby passing through the optical element 30 without being refracted, and is focused on the image forming surface 25.

On the other hand, when the main body 20 is shaken, for example, when the main body 20 is tilted anticlockwise by an angle Θ₁, the subject O is not on the optical axis of the lens 21, as illustrated in FIG. 2B. That is, the optical axis of the lens 21 is tilted with respect to the center of the light transmitted from the subject O towards the lens 21.

If the optical element 30 was not present, the center of the light would progress along line A and would form an image which deviates by a distance Δd from the proper image location of the image forming surface 25.

When the optical element 30 is present, and is tilted counterclockwise by an angle Θ₂ as illustrated in FIG. 2B, the center of the light passing through the optical element 30 is not perpendicular to the incident surface of the optical element 30. Thus, according to Snell's Law, the incident light is refracted by the optical element 30. The shift of the light transmitted from the output surface of the optical element 30 is determined by the tilt angle, thickness, and refractive index of the optical element 30. The shift of the light can be made to correspond to the distance Δd by altering the tilt of the optical element 30, since its thickness and refractive index are fixed.

The sensor 41, provided near the main body 20, senses how much the center of the image has diverted from the desired focusing location by the shaking of the main body 20. Preferably, but not necessarily, the sensor 41 is an angular velocity sensor, which measures the angular velocity of the main body 20. The angular velocity sensor 41 senses in real-time the presence of and the amount of shaking of the main body 20.

The calculating unit 45 receives a sensing signal (for example, information regarding the angular velocity of the main body 20) from the sensor 41 in real-time, and calculates the necessary tilt angle of the optical element 30.

The actuator 50 drives the optical element 30 according to the results output from the calculating unit 45. Referring to FIG. 3, the actuator 50 includes first and second fixing units 53 and 57 which rotatably support the optical element 30, and first and second driving units 51 and 55, which tilt the optical element 30 on the axes provided by the first and second fixing units 53 and 57.

The optical element 30 is installed on a holder 31 so that it can be tilted in all directions with respect to the X-Y plane by the actuator 50. The first driving unit 51 and the first fixing unit 53 are installed on the outer surface of the holder 31, and the second driving unit 55 and the second fixing unit 57 are installed between the holder 31 and the optical element 30.

The first driving unit 51 enables the optical element 30 to pivot with respect to a first axis, for example, the Y-axis. The first driving unit 51 pivots the holder 31 in a direction C, illustrated in FIG. 3, with the first fixing unit 53 as the center. The second driving unit 55, installed on the holder 30, enables the optical element 30 to pivot with respect to a second axis, for example, with respect to the X-axis, which is different from the first axis. That is, the second driving unit 55 enables the optical element 30 to pivot in a direction B, illustrated in FIG. 3, with the second fixing unit 57 as the center.

Therefore, the image stabilizer according to the present exemplary embodiment measures the shaking of the main body 20, caused by pitching and yawning motions of the main body 20, in real-time using the sensor 41. Based on the measured shaking of the main body 20, the calculating unit 45 calculates the tilt angle and the direction of the tilt, and transmits the results to the actuators 50, 55. Then, the actuator 50 drives the optical element 30 with respect to the two axes, based on the input calculated results, to tilt the optical element 30 in a predetermined tilt angle. As a result, the shift of the image due to shaking of the main body 20 can be prevented in real-time by driving the optical element 30.

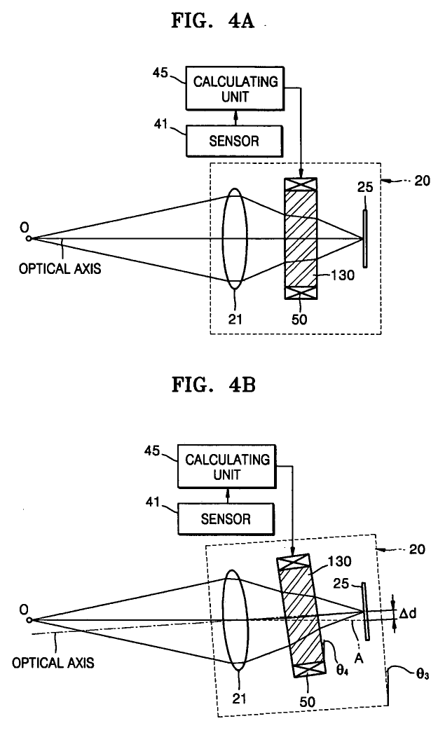

FIGS. 4A and 4B are schematic views of an image stabilizer of a camera according to another exemplary embodiment of the present invention. FIG. 4A illustrates an instance when there is no shaking of a main body 20 of the camera, and FIG. 4B illustrates an instance when the main body 20 is tilted counterclockwise by an angle Θ₃ compared to the position of the main body 20 of the camera as shown in FIG. 4A.

The location of an optical element 130, in the image stabilizer according to the present exemplary embodiment, is different from that of the previous exemplary embodiment. Referring to FIGS. 4A and 4B, the optical element 130 is located between a lens 21 and an image forming surface 25. When the optical element 130 is located in such a position, it is effective even on subjects located at infinity, to compensate for image shift on an image forming surface 25 by tilting the optical element 130 counterclockwise by an angle Θ₄. Since the structure and operation of a sensor 41, a calculating unit 45, and an actuator 50 are the same as in the previous exemplary embodiment, their description will not be repeated.

An image stabilizer of a camera having the above described structure senses camera shake in real-time and adjusts the tilt angle of the optical element 130, to prevent shifting of an image on an image forming surface 25. Consequently, the image formed on the image forming surface is sharp. In addition, by avoiding the need for a liquid-filled bellows, contamination of the inside of the camera can be prevented.

While the present invention has been particularly shown and described with reference to exemplary embodiments thereof, it will be understood by those of ordinary skill in the art that various changes in form and detail may be made to the exemplary embodiments without departing from the spirit and scope of the present invention as defined by the following claims.

What is claimed is:

1. An image stabilizer of a camera which focuses an image on an image forming surface by compensating for a movement of a main body of the camera, which includes a lens, the image stabilizer comprising:
an optical element which is installed on an optical path, wherein the optical element transmits light and is configured to tilt to thereby shift the transmitted light to compensate for the optical path;
a sensor provided near the main body, which senses the movement of the main body;
a calculating unit which receives a sensing signal from the sensor and which calculates a necessary tilt angle of the optical element; and
an actuator which drives the optical element according to a result output from the calculating unit,
wherein the image stabilizer senses the movement of the main body in real-time and prevents shifting of the image focused on the image forming surface in real-time.

2. The image stabilizer of claim 1, wherein the optical element is located on an optical path between a subject and the lens.

3. The image stabilizer of claim 2, wherein the optical element comprises at least one flat glass plate having a refractive index that is higher than a refractive index of air.

4. The image stabilizer of claim 1, wherein the sensor is an angular velocity sensor which measures an angular velocity of the main body caused by movement.

5. The image stabilizer of claim 1, wherein the actuator comprises:
a fixing unit which rotatably supports the optical element; and
a driving unit which tilts the optical element with the fixing unit as a center.

6. The image stabilizer of claim 5, wherein the driving unit comprises:
a first driver which provides a driving force which pivots the optical element on a first axis; and
a second driver which provides a driving force which pivots the optical element on a second axis that is different from the first axis.

7. The image stabilizer of claim 1, wherein the optical element is located on an optical path between the lens and the image forming surface.

8. The image stabilizer of claim 7, wherein the optical element comprises at least one flat glass plate having a refractive index that is higher than a refractive index of air.

9. A system for stabilizing an image formed in a camera, the system comprising:
an optical element which transmits light, wherein the optical element is operable to tilt to thereby shift the transmitted light;
a sensor which senses movement of a main body of the camera in real-time and which generates a sensing signal;
a calculating unit which receives the sensing signal and which calculates a desired tilt angle of the optical element using the sensing signal, wherein the desired tilt angle reduces shifting of an image focused on an image forming surface of the camera in real-time;
an actuator which drives the optical element according to the desired tilt angle calculated by the calculating unit.

10. The system according to claim 9, wherein the optical element is located on an optical path between a subject and a lens.

11. The system according to claim 9, wherein the optical element is located on an optical path between a lens and the image forming surface.

12. The system according to claim 10, wherein the optical element comprises at least one flat glass plate having a refractive index that is higher than a refractive index of air.

13. The system according to claim 11, wherein the optical element comprises at least one flat glass plate having a refractive index that is higher than a refractive index of air.

14. The system according to claim 9, wherein the sensor is an angular velocity sensor which measures an angular velocity of the main body caused by movement.

15. The system according to claim 9, wherein the actuator comprises:
a fixing unit which rotatably supports the optical element; and
a driving unit which pivots the optical element about the fixing unit.

16. The image stabilizer of claim 15, wherein the driving unit comprises:
a first driver which provides a driving force which tilts the optical element about a first axis; and
a second driver which provides a driving force which tilts the optical element about a second axis that is different from the first axis.
